(19) United States
(12) Patent Application Publication
(10) Pub. No.: US 2006/0110999 A1
(43) Pub. Date: May 25, 2006

(54) Antimicrobial preparations for building materials

(75) Inventor: Jimmy McElreath, Plano, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: SCHNEE-MOREHEAD, INC., IRVING, TX (US)

(21) Appl. No.: 10/995,763

(22) Filed: Nov. 22, 2004

(51) Int. Cl. B32B 27/04

(52) U.S. Cl. 442/123; 442/124

(57) ABSTRACT

A system and method of incorporating and coating antimicrobial preparations for building materials by incorporating the antimicrobial preparation into a base material; and forming the base material into a polymer blend and by dispersing an antimicrobial preparation agent evenly in a compatible solution; applying the compatible solution to the building material; and curing the building material to remove the solution. In accordance with the present invention, the building materials that may be used are, for example, house wrap materials, flashing materials, self-adhering flashing materials, sill pans, below grad moisture barriers, subfloor underlayment, roof decks, thresholds, shower pans, material behind or below tile, vapor barriers and any combination thereof. The resulting products will contain antimicrobial preparations distributed throughout the material or coated with the antimicrobial preparations to inhibit the growth of microbes on exterior surfaces and interior regions of the building material.

### BACKGROUND

The present invention relates to the general field of building construction, and in particular, to methods and systems for preventing the accumulation of microbes, such as moisture, mold, mildew, bacteria and fungi, within the building materials.

Currently, there is growing public concern over potential health risks associated with exposure to microbes such as molds, mildew, bacteria and fungi in homes and other buildings. There is particular concern over a host of materials in and around such structures that, under the proper conditions, can become breeding grounds for these microbes. For example, when subjected to climate and weather changes before, during and after construction, exposed drywall paper, wood panels, lumber, concrete, glass, sheathing, fiberboard, plastics, roofs, floor underlayment and carpet backing can potentially be fertile breeding grounds.

Recently, exposure to Stachybotrys, known as “black mold,” has been publicized as a serious health risk and is commonly found in homes. Black mold is most prevalent in homes where moisture from water damage, excessive humidity, water leaks, condensation, water infiltration or flooding is present. Black mold typically grows on materials with a high cellulose and low nitrogen content, such as fiberboard, sheet rock, gypsum board, paper, dust and lint, and flourishes in moisture rich environments. Black mold is considered to be toxic and hazardous when a person breathes or comes in contact with the spores. Oftentimes it takes years before the effects of black mold exposure are detected. Accordingly, most in the construction industry have taken steps to reduce the presence of microbes, such as black mold, in building structures by reviewing their construction practices. In fact, currently the construction industry relies on the quality of its craftsmanship and building design to reduce the presence of microbes.

Home builders, for example, have relied on several different methods to reduce the presence of microbes such as black mold. Some methods have simply utilized plastic sheeting or tarp to protect lumber and other building materials from exposure during the construction phase. Chemical treatments, such as applying mildewcide, are short-term prevention methods, often times unjustifiably increasing material and labor costs. These methods, however, often times fail to take into account protecting the lumber from exposure after construction is complete.

Other prevention methods rely on building design and construction changes. For example, one such prevention method requires including a building material “spacer” impregnated with anti-fungal agents. The building material spacer is usually an open work structure typically placed between two layers of construction. For example, the building material spacer may be placed between the exterior sheathing and the exposed facade material supposedly preventing the growth of mold and mildew within the building structure. Other building material spacers may be designed to channel water out of the building structure. These methods are costly and force the builder to include yet another layer of construction, thereby significantly increasing labor and material costs. Systems in accordance with the present invention make such prevention methods unnecessary.

What is needed is an efficient and cost effective system of protecting building materials before, during and after construction of the building structure. What is further needed is an antimicrobial preparation to inhibit the growth of microbes between and envelop materials and the substrates they contact, for example, exposed drywall paper, wood panels, lumber, concrete, glass, sheathing, fiberboard, plastics and carpet backing. What is still further needed is an antimicrobial preparation to inhibit the growth of microbes inside the building envelope materials and the substrates they contact. What is still further needed is an antimicrobial preparation that may be incorporated into building envelope materials such as house wrap materials, flashing materials, self-adhering flashing materials, sill pans, below grad moisture barriers, subfloor underlayment, roof decks, thresholds, shower pans, behind or below tile and vapor barriers.

What is also needed is an efficient and cost effective method of incorporating an antimicrobial preparation into the base composition of the building material and a method of incorporating an antimicrobial preparation into a coating or ink applied to the building material.

### SUMMARY OF THE INVENTION

The present invention overcomes the aforementioned limitations in an effective and efficient manner, and provides for expanded use of antimicrobial agents to prevent the growth of microbes, such as mold, mildew, bacteria and fungus, between building envelope materials, such as house wrap materials, flashing materials or self-adhering flashing materials, and building substrates including, for example, wood, sheathing and fiberboard building materials. The present invention also prevents the growth of microbes inside building envelope materials and substrates.

In a preferred embodiment, the antimicrobial preparations of the present invention may be incorporated directly into the base composition of the material. For example, the antimicrobial preparation in the base material and incorporated into a polymer blend prior to formation of the final product. The final product will thus contain the antimicrobial preparation incorporated into the material.

In another preferred embodiment, the antimicrobial preparation of the present invention may be incorporated into a coating or ink applied to the material. For example, the antimicrobial preparation is evenly dispersed in a compatible solution. This solution is then applied to the base material and optionally cured to remove part of the combined solution, leaving the antimicrobial preparation bound to the material.

The present invention will provide, for example, antimicrobial preparations for various applications and as building material additive to decrease deterioration of building materials and maintain toxic free environments. The present invention will also provide for improvements in construction, including providing a cost effective and efficient system to protect against microbes and maintain microbe free environment before, during and after building constructions.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

The antimicrobial agents and preparations, hereinafter referred to generally as antimicrobial preparations, of the present invention may be incorporated directly into the base composition of commonly used construction materials, such as building envelope materials. For example, an antimicrobial preparations may be incorporated into a base material before the base material is formed into a into a polymer blend, such as vinyl polymers, polyolefins, film resins and plastics for blow molding application, extruded and film products and injection molded items. Specifically, some of the most common types of polymer materials used as building materials include, for example, high density polyethylene (HDPE) resins and poly(vinyl chloride) (PVC). The resulting products will contain antimicrobial preparations distributed throughout the material including the exterior surfaces and interior regions of the material. Thus, the present invention eliminates the need to use short term prevention methods and precautions known presently.

### EXAMPLE 1

Take, for example, building envelope materials such as house wrap. House wraps are used as weather-resistant barriers to help protect a building structure from water, moisture and air infiltration. House wraps are not, however, microbe inhibiting materials. In accordance with the present invention, pellets of HDPE are combined with antimicrobial preparations before either blow molding or weaving the material into a finished house wrap material. The resulting house wrap material is incorporated with antimicrobial preparations and thus inhibits microbial growth in the house wrap material including the exterior surfaces and interior regions of the material. Similarly, antimicrobial preparations may be incorporated into other building materials.

The antimicrobial preparation of the present invention may also be incorporated into a coating or ink applied directly to the building material. By evenly dispersing the antimicrobial preparation in a compatible solution and then applying the solution to the base material or film, the antimicrobial preparation is bound to the material. Optionally, the combined solution may be cured to remove parts of the solution, leaving only the antimicrobial preparation bound to the building material. Curing, here, is used as a general term but may involve evaporating, drying or chemical spraying the building material with a fan, dryer or chemical sprayer, respectively, or in some combination.

### EXAMPLE 2

Again, using house wrap material as an example, the antimicrobial preparation is dispersed into a compatible solution. The compatible solution may be selected from a wide variety of solutions, such as, inks, coatings, paints, sealants, lacquers and any combination thereof. The combined solution is applied to the house wrap material as a coating. Thus, the antimicrobial preparation is bound to the house wrap material. Optionally, if the builder does not wish to keep the combined solution on the material, the solution may be cured in such a manner to remove parts of the solution, while keeping the antimicrobial preparation bound to the house wrap. The resulting house wrap material is incorporated with antimicrobial preparations and thus inhibits microbial growth in the house wrap material including the exterior surfaces and interior regions of the material.

Accordingly, the present invention will provide, for example, antimicrobial preparations and agents for various applications and as an additive to decrease deterioration of building materials and maintain toxic free environments. The present invention will also provide for example, improvements in construction design while remaining a cost effective and efficient system of protection against microbes before, during and after building construction.

Although preferred embodiments of methods and systems of antimicrobial preparations have been described in detail herein, it will be appreciated that the present invention is discussed in detail herein. It will further be appreciated that the present invention provides may applicable inventive concepts that can be embodied in a wide variety of specific contexts. For example, while the description has principally referenced an antimicrobial preparations for building materials commonly used in construction, it is to be understood that the system may also be utilized for building materials after construction or during maintenance of buildings and the like. The specific embodiments discussed herein are merely illustrative of specific ways to make and use the invention, and do not delimit the scope of the invention. Those skilled in the art will recognize that various substitutions and modifications may be made to the invention without departing from the scope and spirit of the appended claims.

What is claimed is:

1. A method of coating an antimicrobial preparation on building materials comprising:
dispersing an antimicrobial preparation evenly in a compatible solution; and
applying the compatible solution to the building material.

2. The method of claim 1, wherein the antimicrobial preparation inhibits the presence of microbes selected from the group consisting of mold, mildew, bacteria, fungi and any combination thereof.

3. The method of claim 1, wherein the compatible solution is selected from the group consisting of: inks, coatings, paints, sealants, lacquers and any combination thereof.

4. The method of claim 1, wherein the building material is selected from the group consisting of: building envelope materials, house wrap materials, flashing materials, self-adhering flashing materials, sill pans, below grad moisture barriers, subfloor underlayment, roof decks, thresholds, shower pans, material behind or below tile, vapor barriers and any combination thereof.

5. The method of claim 1, further comprising the steps of
curing the building material to remove the solution; and
retaining the antimicrobial preparation.

6. The method of claim 5, wherein curing the building material is accomplished by selecting a curing unit from the group consisting of: a chemical sprayer, a fan, a drying device and any combination thereof.

7. A method of incorporating an antimicrobial preparation for building materials comprising the steps of:
incorporating the antimicrobial preparation into a base material; and
forming the base material into a building material.

8. The method of claim 7, wherein forming the base material into a building material includes a process selected from the group consisting of curing, melting, blow molding, extruding, filming, injection molding and any combination thereof.

9. The method of claim 7, wherein the building material is selected from the group consisting of: building envelope materials, house wrap materials, flashing materials, self-adhering flashing materials, sill pans, below grad moisture barriers, subfloor underlayment, roof decks, thresholds, shower pans, material behind or below tile, vapor barriers and any combination thereof.

10. An building material comprising:
an antimicrobial preparation incorporated into the building material.

11. The building material of claim 10, wherein the antimicrobial preparation inhibits the presence of microbes selected from the group consisting of mold, mildew, bacteria, fungi and any combination thereof.

12. The building material of claim 10 wherein the building material is selected from the group consisting of: building envelope materials, house wrap materials, flashing materials, self-adhering flashing materials, sill pans, below grad moisture barriers, subfloor underlayment, roof decks, thresholds, shower pans, material behind or below tile, vapor barriers and any combination thereof.

13. The building material of claim 10, wherein the antimicrobial preparation inhibits microbial growth on the exterior surfaces and interior regions of the building material.

14. An antimicrobial building material comprising:
a surface; and
an antimicrobial preparation substantially coating the surface.

15. The antimicrobial building material of claim 14, wherein the antimicrobial preparation inhibits the presence of microbes selected from the group consisting of mold, mildew, bacteria, fungi and any combination thereof.

16. The antimicrobial building material of claim 14, wherein the antimicrobial preparation is incorporated into a solution selected from the group consisting of: inks, coatings, paints, sealants, lacquers and any combination thereof.

17. The antimicrobial building material of claim 14, wherein the building material is selected from the group consisting of: building envelope materials, house wrap materials, flashing materials, self-adhering flashing materials, sill pans, below grad moisture barriers, subfloor underlayment, roof decks, thresholds, shower pans, material behind or below tile, vapor barriers and any combination thereof.

18. An antimicrobial building envelope material comprising:
antimicrobial agents incorporated into the building material.

19. The antimicrobial building envelope material of claim 18, wherein the antimicrobial preparation inhibits the presence of microbes selected from the group consisting of mold, mildew, bacteria, fungi and any combination thereof.

20. The antimicrobial building envelope material of claim 18, wherein the building material is selected from the group consisting of: house wrap materials, flashing materials, self-adhering flashing materials, sill pans, below grad moisture barriers, subfloor underlayment, roof decks, thresholds, shower pans, material behind or below tile, vapor barriers and any combination thereof.

21. An antimicrobial building envelope material comprising:
a surface; and
an antimicrobial preparation substantially coating the surface.

22. The antimicrobial building envelope material of claim 21, wherein the antimicrobial preparation inhibits the presence of microbes selected from the group consisting of mold, mildew, bacteria, fungi and any combination thereof.

23. The antimicrobial building envelope material of claim 21, wherein the antimicrobial preparation is incorporated into a solution selected from the group consisting of: inks, coatings, paints, sealants, lacquers and any combination thereof.

24. The antimicrobial building envelope material of claim 21, wherein the building material is selected from the group consisting of: building envelope materials, house wrap materials, flashing materials, self-adhering flashing materials, sill pans, below grad moisture barriers, subfloor underlayment, roof decks, thresholds, shower pans, material behind or below tile, vapor barriers and any combination thereof.
